(19) United States
(12) Patent Application Publication
(10) Pub. No.: US 2020/0367090 A1
(43) Pub. Date: Nov. 19, 2020

(54) APPARATUS AND METHOD FOR HANDLING NETWORKS

(71) Applicant: LENOVO (BEIJING) LIMITED, Beijing (CN)

(72) Inventors: Zhuoyun Zhang, Beijing (CN); Chenxi Zhu, Fairfax, VA (US); Lianhai Wu, Beijing (CN)

(21) Appl. No.: 16/961,401

(22) PCT Filed: Jan. 11, 2018
(86) PCT No.: PCT/CN2018/072266

§ 371 Date: Jul. 10, 2020

(51) Int. Cl. H04W 28/02; H04W 76/27; H04W 76/32

(52) U.S. Cl. CPC H04W 28/0247; H04W 76/32; H04W 76/27

(57) ABSTRACT

The present disclosure relates to methods and apparatuses. According to some embodiments of the disclosure, a method includes determining whether a network is congested; subscribing a state notification of an user equipment (UE) from an access and mobility management function (AMF) if the network is determined as congested; and releasing a protocol data unit (PDU) session if the state notification of the UE indicates that the UE is in a CM-IDLE state or in a radio resource control (RRC) inactive state.

### TECHNICAL FIELD

The present disclosure relates to communication technology, and more particularly relates to apparatus and method for handling networks.

### BACKGROUND

In a communication environment (e.g. a network), network congestion occurs when a network node or link is carrying more data than it can handle or when bandwidth is insufficient and network data traffic exceeds capacity. The congestion may deteriorate quality of service and result in queuing delay, frame or packet loss, the blocking of new connections, etc. In a congested network, response time slows with reduced network throughput.

### SUMMARY OF THE DISCLOSURE

According to some embodiments of the present disclosure, a technical solution is provided to handle a network, e.g. a congested network.

According to some embodiments of the present disclosure, a method includes determining whether a network is congested; subscribing a state notification of an user equipment (UE) from an access and mobility management function (AMF) if the network is determined as congested; and releasing a protocol data unit (PDU) session if the state notification of the UE indicates that the UE is in a CM-IDLE state or in a radio resource control (RRC) inactive state.

According to some embodiments of the present disclosure, a method for handling a network includes sending, by an UE, a PDU session modification request to a network; rejecting the PDU session modification request or SM signaling with a back-off timer; determining a state of the UE; and releasing a PDU session for the UE in accordance with the state of the UE.

According to some embodiments of the present disclosure, a method for handling a network includes sending a request, by a SMF, to an AMF to obtain information indicating a state of a UE; receiving the information indicating the state of the UE; and releasing a PDU session for the UE based on the received information indicating the state of the UE.

Embodiments of the disclosure also provide apparatuses, which can perform the above methods. For example, in some embodiments of the present disclosure, an apparatus may include a processor, a computer, a server or the like which is configured to perform, implement or execute the above methods.

### BRIEF DESCRIPTION OF THE DRAWINGS

In order to describe the manner in which advantages and features of the disclosure can be obtained, a description of the disclosure is rendered by reference to specific embodiments thereof which are illustrated in the appended drawings. These drawings depict only example embodiments of the disclosure and are not therefore to be considered to be limiting of its scope.

FIG. 1 illustrates an exemplary network architecture in accordance with some embodiments of the present disclosure;

FIG. 2 illustrates a method of handling a network in accordance with some embodiments of the present disclosure;

FIG. 3 illustrates a schematic diagram of a PDU session release procedure in accordance with some embodiments of the present disclosure;

FIG. 4 illustrates a schematic diagram of a RRC state transition procedure in accordance with some embodiments of the present disclosure;

FIG. 5 illustrates a schematic diagram of a PDU session release procedure in accordance with some embodiments of the present disclosure.

### DETAILED DESCRIPTION

The detailed description of the appended drawings is intended as a description of the currently preferred embodiments of the present invention, and is not intended to represent the only form in which the present invention may be practiced. It is to be understood that the same or equivalent functions may be accomplished by different embodiments that are intended to be encompassed within the spirit and scope of the present invention.

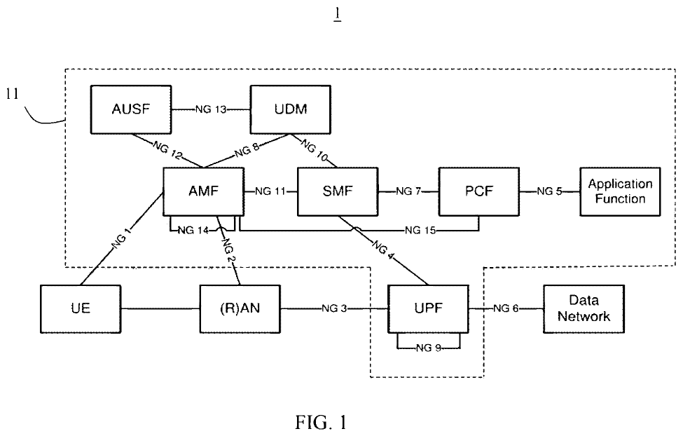

FIG. 1 illustrates an exemplary network architecture 1 in accordance with some embodiments of the present disclosure. The network architecture 1 includes network functions (NFs) and reference points connecting NFs. The network architecture 1 includes an user equipment (UE), a radio access network ((R)AN) (or a base station or an access network (AN)), a data network (DN) and a core network (CN) 11.

The core network 11 includes network functions (NFs), e.g. access and mobility function (AMF), session management function (SMF), policy control function (PCF), application function (AF), authentication server function (AUSF), and user plane function (UPF).

NF has both functional behavior and interface. An NF can be implemented either as a network element on a dedicated hardware, as a software instance running on a dedicated hardware or apparatus, or as a virtualized function instantiated on an appropriate platform, e.g., a cloud infrastructure.

UE is connected to either RAN or AN. RAN represents a base station which may operate based on agreements described in 3G, LTE/LTE-A, 4G or 5G communication standard. For example, the (R)AN may include eNB(s), gNB(s), etc. The (R)AN may also include non-3GPP access, e.g., Wi-Fi.

AMF provides UE-based mobility management, etc. A UE even using multiple access technologies is basically connected to a single AMF because the AMF is independent of the access technologies.

SMF is responsible for session management and allocates IP addresses to UEs. It also selects and controls the UPF for data transfer. If a UE has multiple sessions, different SMFs may be allocated to each session to manage them individually and possibly provide different functionalities per session.

AF interacts with the 3GPP Core Network in order to provide services, for example to support application influence on traffic routing, interacting with the Policy framework for policy control, etc.

AUSF supports Authentication Server Function while UDM stores subscription data of UE.

Data network, which may not be part of the core network 11, provides, for example but is not limited to, internet services or operator owned services.

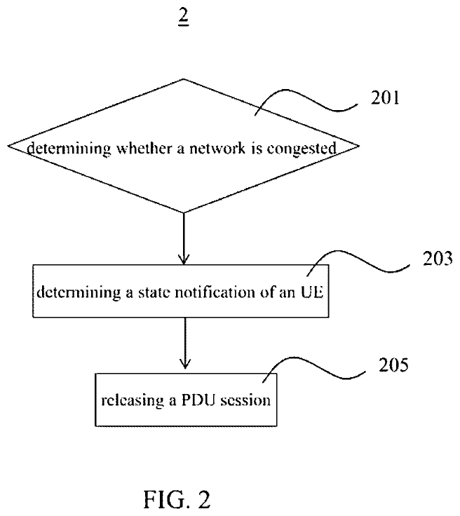

FIG. 2 illustrates a method 2 of handling a network in accordance with some embodiments of the present disclosure. The method 2 includes operation 201, operation 203 and operation 205.

In operation 201, a congestion of a network (e.g. a data network or core network 11 as described and illustrated with reference to FIG. 1) is determined. The congestion may be associated with a data network with certain data network name (DNN). The congestion may be associated with a single network slice identified by single network slice selection assistance information (S-NSSAI).

[DNN-based congestion control] In operation 203, if the network is determined as congested (e.g. if a DNN is determined as congested), SMFs may reject PDU Session Modification Request messages towards DNN (e.g. a specific DNN) from the UE. The PDU Session Modification Request messages may be sent from the UE to the network. SMFs may reject PDU Session Modification Request messages towards DNN (e.g. a specific DNN) with a back-off timer and the associated DNN.

The SMF may subscribe a state notification of the UE from AMF. The SMF may include subscription of RRC inactive state and CM-IDLE state notification towards AMF. The SMF may send a request to AMF to obtain information which indicates a state of an UE. SMFs may substantially simultaneously reject PDU Session Modification Request messages towards DNN (e.g. a specific DNN) and subscribe a state notification of the UE from AMF. SMFs may subscribe a state notification of the UE from AMF subsequent to the rejection of PDU Session Modification Request messages towards DNN (e.g. a specific DNN), from the UE. SMFs may reject PDU Session Modification Request messages towards DNN (e.g. a specific DNN) prior to subscribing a state notification of the UE from AMF.

When receiving the subscription of the state notification of the UE from SMF, and the AMF is aware that the UE is in a CM-IDLE state, the AMF may directly send a CM-IDLE state notification of the UE to the SMF. If the AMF determines that the UE is in a CM-IDLE state after receiving the subscription of the state notification of the UE from SMF, the AMF may directly send a CM-IDLE state notification of the UE to the SMF. The SMF may receive information that indicates the CM-IDLE state of the UE directly from the AMF subsequent to sending a request to AMF to obtain information which indicates the CM-IDLE state of the UE.

[CM-IDLE state] In operation 205, if the SMF receives information that indicates the CM-IDLE state of the UE (or the CM-IDLE state notification of the UE), the SMF may release a PDU session towards this congested DNN. The SMF may decide to release a PDU Session under the scenario that the SMF receives the CM-IDLE state notification of the UE from AMF, if the SMF has already rejected the PDU session modification request from the UE due the congested DNN, and the PDU session doesn't have any Quality of service (QOS) flow with higher priority.

If the PDU Session Release is initiated by the SMF due to the CM-IDLE state notification for the UE which is under DNN based congestion control, the SMF notifies the AMF that the PDU Session is released. The AMF and SMF shall remove all contexts (including the PDU Session ID) associated with the PDU Session which are related with the congested DNN for this UE. AMF shall remove any event subscriptions on the AMF by the SMF as well.

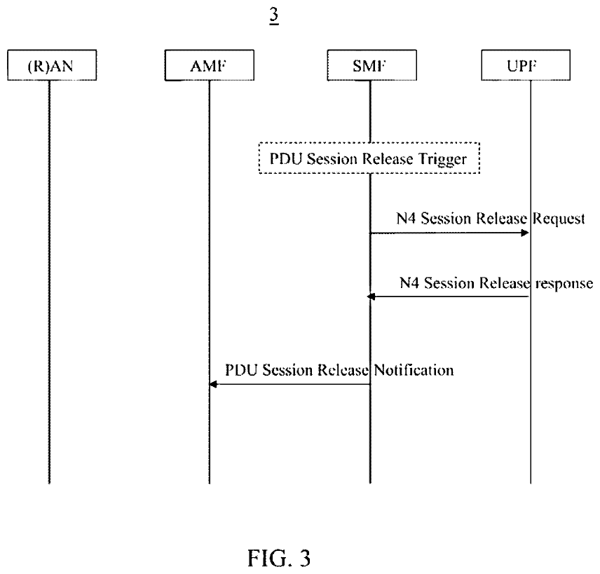

FIG. 3 illustrates a schematic diagram of a PDU session release procedure 3 in accordance with some embodiments of the present disclosure. In the PDU session release procedure 3, if the PDU Session Release is triggered by the SMF due to the CM-IDLE state notification for the UE which is under DNN based congestion control, the SMF notifies the AMF that the PDU Session is released. The SMF sends an N4 Session Release Request (N4 Session ID) message to the UPF(s) of the PDU Session. The UPF(s) shall drop any remaining packets of the PDU Session and release all tunnel resource and contexts associated with the N4 Session. The UPF(s) acknowledges the N4 Session Release Request by the transmission of an N4 Session Release Response (N4 Session ID) message to the SMF.

[RRC inactive state] Referring back to FIG. 2, in operation 203, when receiving the subscription of the state notification (e.g. an RRC inactive state notification) of the UE from SMF, the AMF may initiate an N2 notification procedure (the RRC state transition procedure) towards the base station (e.g. NG-RAN) for this UE. The N2 notification procedure (the RRC state transition procedure) may be referred to clause 4.8.3 of TS 23.502.

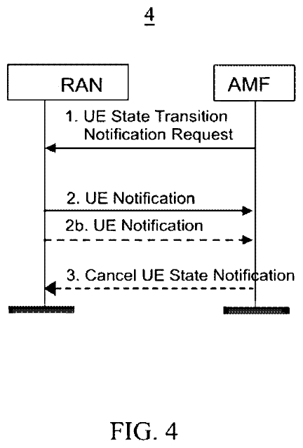

FIG. 4 illustrates a schematic diagram of a RRC state transition procedure 4 in accordance with some embodiments of the present disclosure. In the RRC state transition procedure 4, the AMF sends a request (e.g. UE State Transition Notification Request) to the base station for the RRC Inactive state notification of the UE. The AMF is configured to receive, from the base station, a response (e.g. UE Notification) that indicates the UE is in the RRC Inactive state. The AMF is configured to send the RRC Inactive state notification of the UE to the SMF, subsequent to the receipt of the response from the base station. The AMF cancels the UE state notification after receiving the notification that the UE is in the RRC inactive state, if the AMF has no other triggers for this procedure. When receiving the subscription of RRC inactive state and CM-IDLE state notification from the SMF, the AMF notifies the SMF when the UE is in CM-IDLE state or RRC inactive state.

Referring back to FIG. 2, in operation 205, if the SMF receives information that indicates the RRC inactive state of the UE (or the RRC inactive state notification of the UE), the SMF may release a PDU session. The SMF may decide to release a PDU Session under the scenario that the SMF receives the RRC inactive state notification of the UE from AMF, if the SMF has already rejected the PDU session modification request from the UE due the congested DNN, and the PDU session doesn't have any Quality of service (QOS) flow with higher priority.

If the PDU Session Release is initiated by the SMF due to the RRC inactive state notification for the UE which is under DNN based congestion control, the SMF notifies the AMF that the PDU Session is released. The AMF and SMF shall remove all contexts (including the PDU Session ID) associated with the PDU Session which are related with the congested DNN for this UE. AMF shall remove any event subscriptions on the AMF by the SMF as well. The PDU session release procedure may be the same or similar to the PDU session release procedure 3 as described and illustrated with reference to FIG. 3. If the PDU Session Release is triggered by the SMF due to the RRC inactive state notification for the UE which is under DNN based congestion control, the SMF notifies the AMF that the PDU Session is released.

[S-NSSAI-based congestion control] Referring back to FIG. 2, in operation 203, if the network is determined as congested (e.g. if an S-NSSAI is determined as congested), then the SMF may apply S-NSSAI based congestion control towards the UE. The SMF may apply S-NSSAI based congestion control towards the UE for session management (SM) requests. The S-NSSAI based congestion control includes an S-NSSAI and provides a back-off timer and an associated S-NSSAI (and optionally a DNN).

The SMF may subscribe a state notification of the UE from AMF. The SMF may include subscription of RRC inactive state and CM-IDLE state notification towards AMF. The SMF may send a request to AMF to obtain information which indicates a state of an UE. SMFs may substantially simultaneously apply S-NSSAI based congestion control towards the UE and subscribe a state notification of the UE from AMF. SMFs may subscribe a state notification of the UE from AMF subsequent to the application of S-NSSAI based congestion control towards the UE. SMFs may apply S-NSSAI based congestion control towards the UE prior to subscribing a state notification of the UE from AMF.

[CM-IDLE state] When receiving the subscription of the state notification of the UE from SMF, and the AMF is aware that the UE is in a CM-IDLE state, the AMF may directly send a CM-IDLE state notification of the UE to the SMF. If the AMF determines that the UE is in a CM-IDLE state after) receiving the subscription of the state notification of the UE from SMF, the AMF may directly send a CM-IDLE state notification of the UE to the SMF. The SMF may receive information that indicates the CM-IDLE state of the UE directly from the AMF subsequent to sending a request to AMF to obtain information which indicates the CM-IDLE state of the UE.

In operation 205, if the SMF receives information that indicates the CM-IDLE state of the UE (or the CM-IDLE state notification of the UE), the SMF may release a PDU session towards this congested DNN. The SMF may decide to release a PDU Session under the scenario that the SMF receives the CM-IDLE state notification of the UE from AMF.

If the PDU Session Release is initiated by the SMF due to the CM-IDLE state notification for the UE which is under S-NSSAI based congestion control, the SMF notifies the AMF that the PDU Session is released. The AMF and SMF shall remove all contexts (including the PDU Session ID) associated with the PDU Session which are related with the congested DNN for this UE. AMF shall remove any event subscriptions on the AMF by the SMF as well. The PDU session release procedure may be the same or similar to the PDU session release procedure 3 as described and illustrated with reference to FIG. 3. If the PDU Session Release is triggered by the SMF due to the RRC inactive state notification for the UE which is under DNN based congestion control, the SMF notifies the AMF that the PDU Session is released.

[RRC inactive state] Referring back to FIG. 2, in operation 203, when receiving the subscription of the state notification (e.g. an RRC inactive state notification) of the UE from SMF, the AMF may initiate an N2 notification procedure (the RRC state transition procedure) towards the base station (e.g. NG-RAN) for this UE. The N2 notification procedure (the RRC state transition procedure) may be referred to clause 4.8.3 of TS 23.502.

FIG. 4 illustrates a schematic diagram of a RRC state transition procedure 4 in accordance with some embodiments of the present disclosure. In the RRC state transition procedure 4, the AMF sends a request (e.g. UE State Transition Notification Request) to the base station for the RRC Inactive state notification of the UE. The AMF is configured to receive, from the base station, a response (e.g. UE Notification) that indicates the UE is in the RRC Inactive state. The AMF is configured to send the RRC Inactive state notification of the UE to the SMF, subsequent to the receipt of the response from the base station. The AMF cancels the UE state notification after receiving the notification that the UE is in the RRC inactive state, if the AMF has no other triggers for this procedure. When receiving the subscription of RRC inactive state and CM-IDLE state notification from the SMF, the AMF notifies the SMF when the UE is in CM-IDLE state or RRC inactive state.

Referring back to FIG. 2, in operation 205, if the SMF receives information that indicates the RRC inactive state of the UE (or the RRC inactive state notification of the UE), the SMF may release a PDU session. The SMF may decide to release a PDU Session under the scenario that the SMF receives the RRC inactive state notification of the UE from AMF.

If the PDU Session Release is initiated by the SMF due to the RRC inactive state notification for the UE which is under S-NSSAI based congestion control, the SMF notifies the AMF that the PDU Session is released. The AMF and SMF shall remove all contexts (including the PDU Session ID) associated with the PDU Session which are related with the congested DNN for this UE. AMF shall remove any event subscriptions on the AMF by the SMF as well. The PDU session release procedure may be the same or similar to the PDU session release procedure 3 as described and illustrated with reference to FIG. 3. If the PDU Session Release is triggered by the SMF due to the RRC inactive state notification for the UE which is under S-NSSAI based congestion control, the SMF notifies the AMF that the PDU Session is released.

[PDU session release triggered by AMF] Referring back to FIG. 2, in operation 203, if the DNN or S-NSSAI is determined as congested, the AMF may provide a non-access stratum (NAS) Transport Error message for the NAS Transport message carrying a session management (SM) message towards the UE. The NAS

Transport Error message may include a back-off timer and the associated DNN. The NAS Transport Error message may include a back-off timer and the associated S-NSSAI. The NAS Transport Error message may include a back-off timer and an associated S-NSSAI and optionally in addition a DNN. If the PDU session is still maintained by the SMF, the AMF includes the subscription of the RRC Inactive state to the base station using N2 notification procedure at the same time with or after providing the non-access stratum (NAS) Transport Error message to the UE.

When the AMF receives the RRC inactive state notification of the UE from the base station or when the AMF detects the UE is in the CM-IDLE state, after providing the NAS Transport Error message including a back-off timer to the UE due to DNN or S-NSSAI congestion, the AMF may invoke a Nsmf_PDUSession_ReleaseSMContext service operation to request the release of the PDU Sessions for the UE for the congested DNN or S-NSSAI. The AMF may send the PDU session release request to the SMF to release the PDU Session for the UE for the congested DNN or S-NSSAI

If the PDU Session Release is initiated by the AMF (e.g. the SMF receives the Nsmf_PDUSession_ReleaseSMContext Request from the AMF), the SMF responds to the AMF with the Nsmf_PDUSession_ReleaseSMContext response. If the PDU Session Release is triggered by receiving the RRC inactive notification for the UE under congestion control, the AMF shall remove all contexts (including the PDU Session ID) associated with the PDU Sessions which are related with the congested DNN or S-NSSAI for this UE. AMF shall remove the related event subscriptions on the AMF as well.

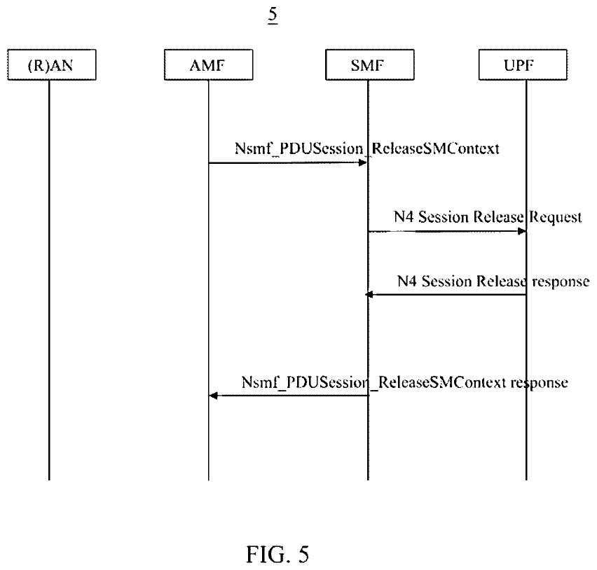

FIG. 5 illustrates a schematic diagram of a PDU session release procedure 5 in accordance with some embodiments of the present disclosure. In the PDU session release procedure 5, when the AMF receives the RRC inactive state notification of the UE from the base station or when the AMF is aware that the UE is in the CM-IDLE state, after providing the NAS Transport Error message including a back-off timer to the UE due to DNN or S-NSSAI congestion, the AMF may trigger a Nsmf_PDUSession_ReleaseSMContext service operation to request the release of the PDU Sessions for the UE for the congested DNN or S-NSSAI.

If the PDU Session Release is triggered by the AMF (e.g. the SMF receives the Nsmf_PDUSession_ReleaseSMContext Request from the AMF), the SMF responds to the AMF with the Nsmf_PDUSession_ReleaseSMContext response. If the PDU Session Release is triggered by receiving the RRC inactive notification for the UE under congestion control, the AMF shall remove all contexts (including the PDU Session ID) associated with the PDU Sessions which are related with the congested DNN or S-NSSAI for this UE. AMF shall remove the related event subscriptions on the AMF as well. The SMF sends an N4 Session Release Request (N4 Session ID) message to the UPF(s) of the PDU Session. The UPF(s) shall drop any remaining packets of the PDU Session and release all tunnel resource and contexts associated with the N4 Session. The UPF(s) acknowledges the N4 Session Release Request by the transmission of an N4 Session Release Response (N4 Session ID) message to the SMF.

[PDU session release triggered by SMF] Referring back to FIG. 2, in operation 203, if the DNN or S-NSSAI is determined as congested, the SMF may subscribe a state notification (RRC inactive state notification or CM-IDLE state notification) of the UE from AMF. The SMF may subscribe the RRC inactive state notification and the CM-IDLE state notification towards the AMF for the UEs that have the PDU sessions towards the congested DNN or S-NSSAI. If the UE is in CM-IDLE state, the AMF (which is aware of the CM-IDLE state of the UE) notifies the SMF that the UE is in CM-IDLE state. If the UE is in CM-CONNECTED state, the AMF further initiates the N2 notification procedure (the RRC state transition procedure) towards the base station for this UE. The AMF notifies the SMF if it receives the indication from the base station that the UE is in RRC inactive state or it determines that the UE is in a CM-IDLE state. The SMF releases the PDU sessions towards the congested DNN or S-NSSAI for the UEs in CM-IDLE state or RRC inactive state, including the back-off timer. The SMF sends the back-off timer towards the congested DNN or S-NSSAI for the UEs in CM-IDLE state or RRC inactive state.

The PDU session release procedure as described above is performed or completed in the core network. The AMF receives PDU session release notification from the SMF without further notifying or forwarding message(s) to the UE. For example, in FIG. 3, after receiving PDU session release notification from the SMF, the AMF does not signal any information relevant to the release of PDU session to the UE. For example, in FIG. 5, after receiving Nsmf_PDUSession_ReleaseSMContext response from the SMF, the AMF does not signal any information relevant to the release of PDU session to the UE.

One of various advantages of the above-mentioned methods is that the consumption of resources in the network (e.g. core network) for the congestion situation may be reduced due to the release of the PDU sessions by the SMF towards the congested DNN or S-NSSAI for the UEs in CM-IDLE state or RRC inactive state, including the back-off timer. Another one of various advantages of the above-mentioned methods is that the PDU session of the UE, which is in CM-CONNECTED state and RRC-connected state, is remained.

[DNN based congestion control] SMFs may apply DNN based congestion control towards the UE by rejecting PDU Session Establishment/Modification Request messages towards a specific DNN, from the UE, with a back-off timer and the associated DNN. The SMF may release PDU Sessions belonging to a congested DNN by sending a PDU Session Release Request message towards the UE with a back-off timer. If back-off timer is set in the PDU Session Release Request message then the cause “reactivation requested” should not be set. The AMF may provide a NAS Transport Error message for the NAS Transport message carrying an SM message and in the NAS Transport Error message include a back-off timer and the associated DNN. While the back-off timer for the specific DNN is running, then the UE will not send any NAS messages for the specific DNN.

The UE receives the back-off timer from either AMF or SMF, but the PDU session may still be maintained by the SMF (e.g. when the PDU Session Modification Request message is rejected). In this case, even if the UE is in RRC-inactive state or CM-IDLE state after the UE's receiving of the back-off timer, the PDU session may still be maintained by the SMF, which is a waste of resources in the network (e.g. core network) for the congestion situation. If the DNN is congested, the SMF may actively release PDU Sessions belonging to a congested DNN by sending a PDU Session Release Request message towards the UE with a back-off timer. However, such manner may adversely affect the UE which is in CM-CONNECTED state and RRC-connected state.

[S-NSSAI based congestion control] If an S-NSSAI is determined as congested, then the SMF may apply S-NSSAI based congestion control towards the UE for SM requests which includes an S-NSSAI, and provides a back-off timer, and an associated S-NSSAI and optionally a DNN. The SMF may release PDU Sessions belonging to a congested S-NSSAI by sending a PDU Session Release Request message towards the UE with a back-off timer associated to the S-NSSAI and optionally a DNN. If an S-NSSAI is determined as congested, then the AMF may apply S-NSSAI based congestion control towards the UE, by providing an NAS Transport Error message for the NAS Transport message carrying the SM message and in the NAS Transport Error message include a back-off timer and an associated S-NSSAI and optionally in addition a DNN.

The UE receives the back-off timer from either AMF or SMF, but the PDU session may still be maintained by the SMF (e.g. when the PDU Session Modification Request message is rejected). In this case, even if the UE is in RRC-inactive state or CM-IDLE state after the UE's receiving of the back-off timer, the PDU session may still be maintained by the SMF, which is a waste of resources in the network (e.g. core network) for the congestion situation. If the S-NSSAI is congested, the SMF may actively release PDU Sessions belonging to a congested S-NSSAI by sending a PDU Session Release Request message towards the UE with a back-off timer. However, such manner may adversely affect the UE which is in CM-CONNECTED state and RRC-connected state.

In some embodiments, one or more or all of the operations as shown in FIGS. 1-5 can be performed by an apparatus, a device or a system. The apparatus or device may include but is not limited to, for example, a processor, a computer, a server or the like. For example, one or more or all of the operations as shown in FIGS. 1-5 can be performed by a base station or other processing unit(s) reside in the base station. For example, one or more or all of the operations as shown in FIGS. 1-5 can be performed by an UE or other processing unit(s) reside in the UE. For example, one or more or all of the operations as shown in FIGS. 1-5 can be performed by an as described above or other processing unit(s) reside in the NF.

While this disclosure has been described with specific embodiments thereof, it is evident that many alternatives, modifications, and variations may be apparent to those skilled in the art. For example, various components or operations of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

1. A method, comprising:
determining whether a network is congested;
subscribing a state notification of a user equipment from an access and mobility management function if the network is determined as congested; and
releasing a protocol data unit session if the state notification of the user equipment indicates that the user equipment is in a connection management-IDLE state or in a radio resource control inactive state.

2. The method of claim 1, wherein if the network is determined as congested, the method further comprises a data network name based congestion control or a single network slice selection assistance information based congestion control.

3. The method of claim 1, wherein releasing the protocol data unit session comprises releasing the protocol data unit session for the user equipment by a session management function.

4. The method of claim 1, wherein releasing the protocol data unit session comprises releasing the protocol data unit session for the user equipment by a session management function triggered by the access and mobility management function.

5. The method of claim 1, wherein subscribing the state notification comprises subscribing the state notification of the user equipment by a session management function.

6. The method of claim 5, wherein subsequent to subscribing the state notification, the access and mobility management function directly sends the connection management-IDLE state notification of the user equipment to the session management function if the user equipment is in the connection management-IDLE state.

7. The method of claim 5, wherein the access and mobility management function is configured to:
send a request to a base station for the radio resource control Inactive state notification of the user equipment;
receive, by the access and mobility management function from the base station, a response that indicates the user equipment is in the radio resource control Inactive state; and
send the radio resource control Inactive state notification of the user equipment to the session management function, subsequent to receiving the response from the base station.

8. The method of claim 7, wherein the session management function is configured to release the protocol data unit session for the user equipment subsequent to receiving the radio resource control Inactive state notification of the user equipment from the access and mobility management function.

9. (canceled)

10. (canceled)

11. A method for handling a network, comprising:
sending, by a user equipment, a protocol data unit session modification request to a network;
determining a state of the user equipment; and
releasing a protocol data unit session for the user equipment in accordance with the state of the user equipment.

12. The method of claim 11, wherein releasing the protocol data unit session comprises releasing the protocol data unit session for the user equipment if the state of the user equipment is a connection management-IDLE state or a radio resource control-inactive state.

13. The method of claim 11, wherein determining the state of the user equipment comprises determining the connection management-IDLE state of the user equipment by an access and mobility management function.

14. The method of claim 11, wherein determining the state of the user equipment comprises sending a request to a base station by an access and mobility management function for the radio resource control Inactive state of the user equipment.

15. The method of claim 11, further comprising rejecting the protocol data unit session modification request by an session management function prior to or as part of determining the state of the user equipment.

16. The method of claim 11, further comprising sending an non-access stratum transport error message to the user equipment by an access and mobility management function prior to or as part of determining the state of the user equipment.

17. The method of claim 11, wherein the network is handled by a data network name-based congestion control and an single network slice selection assistance information-based congestion control.

18. A method for handling a network, comprising:
sending a request, by a session management function, to an access and mobility management function to obtain information indicating a state of a user equipment;
receiving the information indicating the state of the user equipment; and
releasing a protocol data unit session for the user equipment based on the received information indicating the state of the user equipment.

19. The method of claim 18, further comprising releasing the protocol data unit session for the user equipment if the state of the user equipment is indicated as a connection management-IDLE state or a radio resource control-inactive state.

20. The method of claim 18, wherein receiving the information comprises receiving the information indicating the connection management-IDLE state of the user equipment directly from the access and mobility management function.

21. The method of claim 18, wherein receiving the information comprises:
sending a request to a base station by the access and mobility management function for the radio resource control-inactive state of the user equipment; and
receiving, by the access and mobility management function from the base station, a response that indicates the user equipment is in the radio resource control Inactive state.

22. The method of claim 21, further comprising sending the information indicating the radio resource control Inactive state of the user equipment to the session management function by the access and mobility management function, subsequent to the receipt of the response from the base station.

23. (canceled)
